(19) United States
(12) Patent Application Publication
(10) Pub. No.: US 2007/0101589 A1
(43) Pub. Date: May 10, 2007

(54) Multiangle cutting saw

(75) Inventor: Peter (Hao) Wen, Shanghai (CN)

Correspondence Address: EDMONDS, P.C., 16815 ROYAL CREST DRIVE, SUITE 130, HOUSTON, TX, 77058, US

(73) Assignee: KRAFTOOL MFG. (SHANGHAI) CO., LTD., SHANGHAI (CN)

(21) Appl. No.: 11/545,813

(22) Filed: Oct. 10, 2006

(30) Foreign Application Priority Data
Oct. 10, 2005 (CN) 200510030343.3

(51) Int. Cl. B27B 21/00

(52) U.S. Cl. 30/514

(57) ABSTRACT

A multi-angle cutting saw that can protect saw teeth from damage, perform multi-angle cutting, and is easy to transport, is provided. The saw includes a handle, a locking bolt, a saw blade, a guide block, and a return mechanism. The saw blade can be installed in the horizontal saw blade hole of the handle through the locking bolt. The guide block, which can be parallel to the saw blade and can rotate along with the saw blade and can penetrate through the handle, can be installed in the horizontal guide hole on the bottom surface of the horizontal saw blade hole in the handle. The saw blade can pass through the saw slot at the upper end of a support frame. The support frame, which can move along the saw blade together with the guide block, can be installed at the end of the guide block. The return mechanism, which is installed inside the upper end of the handle and can drive the guide block to move, can be connected to the spring clip at the other end of the guide block. A position limiting device, which can stop movement of the guide block, can be installed at the lower end of the support frame. A hole can be formed outside the horizontal guide hole at the upper end of the handle. A horizontal stop piece can be installed outside the horizontal guide hole.

### CROSS REFERENCE TO RELATED APPLICATION

This application claims the benefit under 35 USC §119 of Chinese Patent Application having Application Serial No. 200510030343.3 filed on Oct. 10, 2005, which is incorporated by reference herein.

### BACKGROUND OF THE INVENTION

1. Field of the Invention

Embodiments of the present invention generally relate to a saw. More particularly, embodiments of the present invention relate to a type of saw that can perform multi-angle cuts with respect to various types of materials in various shapes.

2. Description of the Related Art

Saws are popular tools used in daily life. UK Patent Application No. 2353756, c1.B23D49/10, 07.03.2001/filed in 2001 describes a saw that includes a handle, saw blade, guide block, and return mechanism. The saw blade is sandwiched between the handle and the guide block. The return mechanism can control the relative movement between the handle and the guide block. This saw, however, suffers from a working angle that is fixed and cannot be adjusted; and the saw is too large and cannot be transported easily.

There is a need, therefore, for a type of saw that can perform multi-angle cuts with respect to various types of materials in various shapes And that can be easily transported.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 shows a schematic illustration a saw that can perform multi-angle cutting according to one or more embodiments described.

FIG. 2 shows a schematic illustration of the rear view of a saw that can perform multi-angle cutting according to one or more embodiments described.

FIG. 3 shows a schematic illustration of a structure when cross-cutting is performed according to one or more embodiments described.

FIG. 4 shows a schematic illustration of a structure when longitudinal cutting is performed according to one or more embodiments described.

FIG. 5 shows a schematic illustration of a structure when the guide block and the saw blade are pushed into the handle according to one or more embodiments described.

### SUMMARY OF THE INVENTION

A multi-angle cutting saw that can protect saw teeth from damage, perform multi-angle cutting, and is easy to transport, is provided. The saw includes a handle, a locking bolt, a saw blade, a guide block, and a return mechanism. The saw blade can be installed in the horizontal saw blade hole of the handle through the locking bolt. The guide block, which can be parallel to the saw blade and can rotate along with the saw blade and can penetrate through the handle, can be installed in the horizontal guide hole on the bottom surface of the horizontal saw blade hole in the handle. The saw blade can pass through the saw slot at the upper end of a support frame. The support frame, which can move along the saw blade together with the guide block, can be installed at the end of the guide block. The return mechanism, which is installed inside the upper end of the handle and can drive the guide block to move, can be connected to the spring clip at the other end of the guide block. A position limiting device, which can stop movement of the guide block, can be installed at the lower end of the support frame. A hole can be formed outside the horizontal guide hole at the upper end of the handle. A horizontal stop piece can be installed outside the horizontal guide hole.

### DETAILED DESCRIPTION

A detailed description will now be provided. Each of the appended claims defines a separate saw, which for infringement purposes is recognized as including equivalents to the various elements or limitations specified in the claims. Depending on the context, all references below to the “saw” may in some cases refer to certain specific embodiments only. In other cases it will be recognized that references to the “saw” will refer to subject matter recited in one or more, but not necessarily all, of the claims. Each of the saws will now be described in greater detail below, including specific embodiments, versions and examples, but the saws are not limited to these embodiments, versions or examples, which are included to enable a person having ordinary skill in the art to make and use the saws, when the information in this patent is combined with available information and technology.

In one or more embodiments, a saw is provided that has a small volume and can perform multi-angle cutting. In one or more embodiments, the saw blade can change angles.

In one or more embodiments herein, the saw can perform multi-angle cutting and includes a handle, a locking bolt, a saw blade, a guide block, and a return mechanism. The saw blade can be installed in the horizontal saw blade hole of the handle through the locking bolt. The guide block, which can be parallel to the saw blade and can rotate along with the saw blade and can penetrate through the handle, can be installed in the horizontal guide hole on the bottom surface of the horizontal saw blade hole in the handle. The saw blade can pass through the saw slot at the upper end of a support frame. The support frame, which can move along the saw blade together with the guide block, can be installed at the end of the guide block. The return mechanism, which is installed inside the upper end of the handle and can drive the guide block to move, can be connected to the spring clip at the other end of the guide block. A position limiting device, which can stop movement of the guide block, can be installed at the lower end of the support frame. A hole can be formed outside the horizontal guide hole at the upper end of the handle. A horizontal stop piece can be installed outside the horizontal guide hole.

In one or more embodiments above or elsewhere herein, a vertical guide hole and a vertical saw blade hole that are parallel to one another can be formed in the handle. A vertical stop piece can be installed on one side of the vertical guide hole at the lower end of the handle. A saw blade slot can be formed at the upper end of the aforementioned support frame.

In one or more embodiments, the guide block can protect the saw blade when it is not in use. When the saw is in use, the horizontal stop piece can be lifted. The return mechanism can make the guide block move. Guide block movement can be stopped by the position limiting device. The saw blade can be exposed to perform cross-cutting. In one or more embodiments, if the lock nut is unfastened, the guide block and the saw blade can rotate. After they are rotated to a desired angle and the lock nut is fastened, the saw can perform cutting again. In one or more embodiments, the saw blade can insert into the vertical guide hole and the vertical saw blade hole to perform longitudinal cutting. The lock nut can be unfastened to push both the guide block and the saw blade into the handle. After they have contact with the position limiting device, the lock nut can be fastened to reduce the volume of the entire product so that it can be transported easily.

In one or more embodiments, the present saw includes advantages of saw teeth protection from damage, realization of multi-angle cutting, and easy transport.

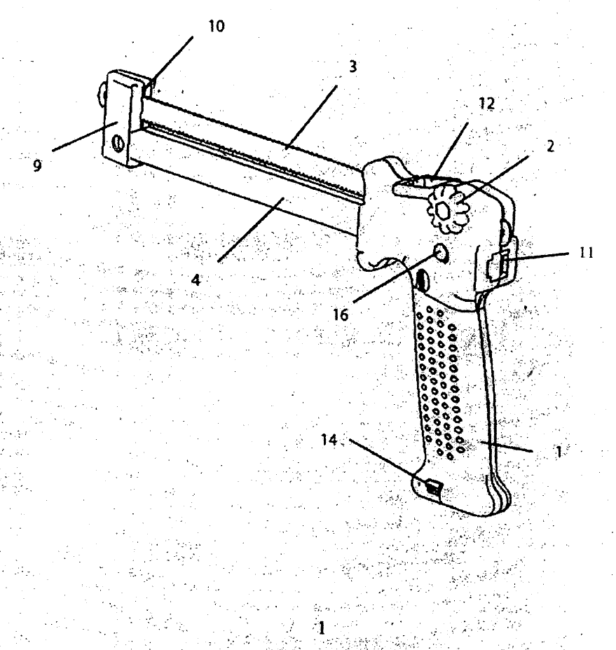

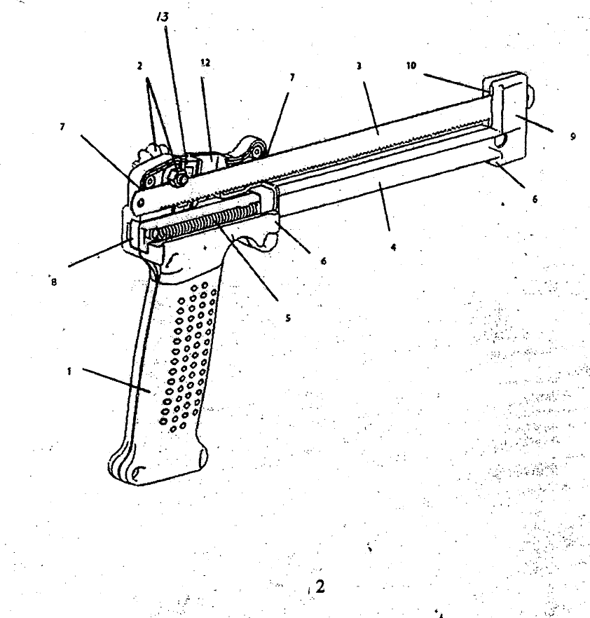

FIG. 1 shows a schematic illustration a saw that can perform multi-angle cutting according to one or more embodiments described. FIG. 2 shows a schematic illustration of the rear view of a saw that can perform multi-angle cutting according to one or more embodiments described. Referring to FIGS. 1 and 2, the saw can include a handle 1, locking bolt 2, saw blade 3, guide block 4, return mechanism 5, position limiting device 6, support frame 9, horizontal stop piece 11, vertical stop piece 14, and spring clip 15. In one or more embodiments, the handle 1, guide block 4, support frame 9, horizontal stop piece 11, and vertical stop piece 14 are all plastic injection-molded products. Saw blade 3 can be installed in horizontal saw blade hole 7 of handle 1 via locking bolt 2. Guide block 4 can be installed in the horizontal guide hole 8 on the bottom surface of horizontal saw blade hole 7 in handle 1. Guide block 4 can be parallel to saw blade 3 and can rotate along with saw blade 3. Guide block 4 can also move to cross handle 1. Saw blade slot 10 can be formed at the upper end of support frame 9. Saw blade 3 can pass through saw blade slot 10 at the upper end of support frame 9. Support frame 9 can be installed at the end of guide block 4. Support frame 9, which can move along saw blade 3 together with guide block 4, can be installed at the end of guide block 4. Return mechanism 5 can be installed inside the upper end of handle I and can be connected to spring clip 15 at the other end of guide block 4 and can drive guide block 4 to move. Position limiting device 6 can be installed at the lower end of support frame 9 and can stop movement of guide block 4. Hole 16 can be formed outside the horizontal guide hole 8 at the upper end on handle 1. Horizontal stop piece 11 can be installed outside horizontal guide hole 8.

In one or more embodiments, a vertical guide hole 12 and a vertical saw blade hole 13 that are parallel to one another can also form in handle 1. Vertical stop piece 14 can be installed on one side of vertical guide hole 12 at the lower end of handle 1. In one or more embodiments, when the saw is not in use, guide block 4 can protect saw blade 3 and horizontal stop piece 11 can press down to fix the guide block.

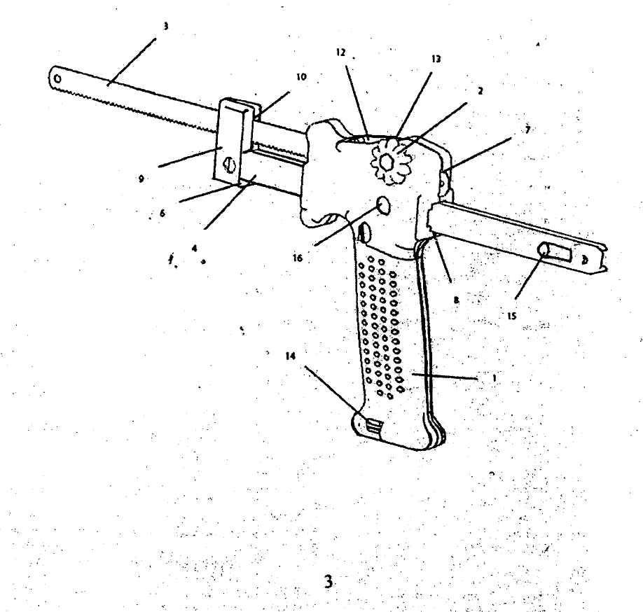

FIG. 3 shows a schematic illustration of a structure when cross-cutting is performed according to one or more embodiments described. FIG. 3 also depicts a state when the saw performs transversal cutting. Saw blade 3 can be perpendicular to handle 1. Horizontal stop piece 1 can be lifted. Return mechanism 5 can make guide block 4 move, and the movement can be stopped by position limiting device 6. Saw blade 3 can be exposed to perform cutting.

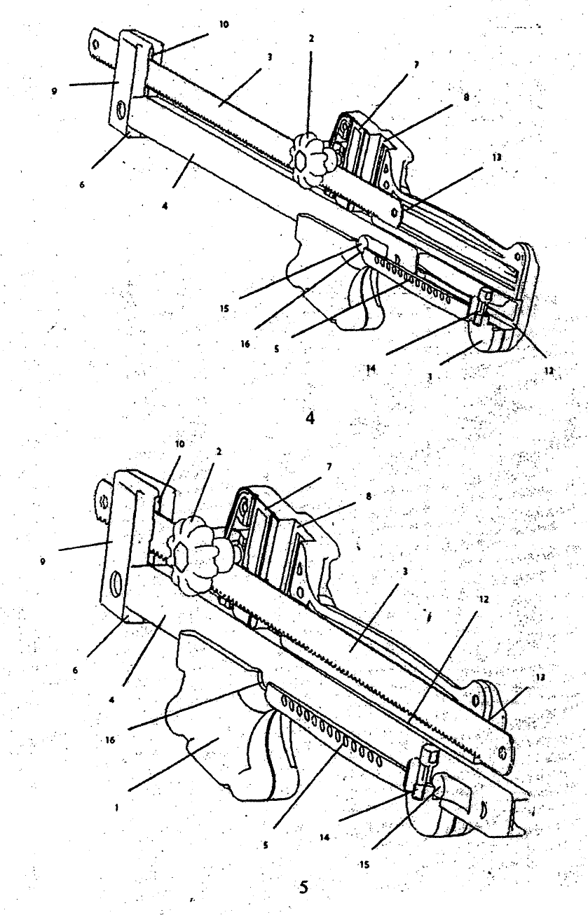

FIG. 4 shows a schematic illustration of a structure when longitudinal cutting is performed according to one or more embodiments described. Lock nut 2 can be unfastened so that guide block 4 and saw blade 3 can rotate. After they are rotated to a desired angle, lock nut 2 can be fastened, and the saw can perform cutting again. In one or more embodiments, the guide block 4 and saw blade 3 can be inserted into vertical guide hole 12 and vertical saw blade hole 13. Saw blade 3 can be in parallel with handle 1 to perform longitudinal cutting.

FIG. 5 shows a schematic illustration of a structure when the guide block and the saw blade are pushed into the handle according to one or more embodiments described. In one or more embodiments, to transport the saw, lock nut 2 can be unfastened to push both guide block 4 and saw blade 3 into handle 1. After they have contact with position limiting device 6, lock nut 2 can be fastened to reduce the volume of the entire product. In one or more embodiments, the present saw can be used to perform multi-angle cutting with respect to various types of materials in various shapes.

In another embodiment, the present invention relates to:

1. A type of saw that can perform multi-angle cutting, comprising-a handle (1), a locking bolt (2), a saw blade (3), a guide block (4), and a return mechanism (5), characterized by the following facts: saw blade (3) is installed in a horizontal saw blade hole (7) of handle (1) through locking blot (2); guide block (4), which is parallel to saw blade (3) and can rotate along with the saw blade and can penetrate through handle (1), is installed in a horizontal guide hole (8) on the bottom surface of horizontal saw blade hole (7) in handle (1); saw blade (3) passes through a saw slot (10) at the upper end of a support frame (9); support frame (9) that can move along saw blade (3) together with guide block (4) is installed at the end of guide block (4); return mechanism (5), which is installed inside the upper end of handle (1) and can drive guide block (4) to move, is connected to a spring clip (15) at the other end of guide block (4); a position limiting device (6) that can stop movement of guide block (4) is installed at the lower end of support frame (9); a hole (16) is formed outside horizontal guide hole (8) at the upper end of handle (1); and a horizontal stop piece (11) is installed outside the horizontal guide hole (8).2.

2 The saw that can perform multi-angle cutting described in paragraph 1, characterized by the fact that a vertical guide hole (12) and a vertical saw blade hole (13) that are parallel to one another are formed in said handle (1); a vertical stop piece (14) is installed on one side of vertical guide hole (12) at the lower end of handle (1).

3. The saw that can perform multi-angle cutting described in paragraphs 1 or 2, characterized by the fact that a saw blade slot (10) is formed at the upper end of said support frame (10).

In another embodiment, the present invention relates to:

1. A saw comprising:

a handle (1);

a locking bolt (2);

a saw blade (3);

a guide block (4); and

a return mechanism (5).

2. The saw of paragraph 1, wherein the saw blade (3) is installed in a horizontal saw blade hole (7) of the handle (1) through locking bolt (2).

3. The saw of paragraphs 1 or 2, wherein the guide block (4) which is parallel to saw blade (3) and can rotate along with the saw blade and move through the handle (1) is installed in a horizontal guide hole (8) on the bottom surface of horizontal saw blade hole (7) in the handle (1).

4. The saw of any of paragraphs 1 to 3, wherein the saw blade (3) passes through a saw blade slot (10) at the upper end of a support frame (9).

5. The saw of any of paragraphs 1 to 4, wherein the support frame (9) that can move along saw blade (3) together with guide block (4) is installed at the end of guide block (4).

6. The saw of any of paragraphs 1 to 5, wherein the return mechanism (5), which is installed inside the upper end of the handle (1) and can drive guide block (4) to move, is connected to a spring clip (15) at the other end of guide block (4).

7. The saw of any of paragraphs 1 to 6, wherein a position limiting device (6) that can stop movement of guide block (4) is installed at the lower end of support frame (9).

8. The saw of any of paragraphs 1 to 7, wherein a hole (16) is formed outside horizontal guide hole (8) at the upper end of handle (1).

9. The saw of any of paragraphs 1 to 8, wherein a horizontal stop piece (11) is installed outside the horizontal guide hole (8).

10. The saw of any of paragraphs 1 to 9, wherein a vertical guide hole (12) and a vertical saw blade hole (13) that are parallel to one another are formed in said handle (1); and wherein a vertical stop piece (14) is installed on one side of vertical guide hole (12) at the lower end of handle (1).

11. The saw of any of paragraphs 1 to 10, wherein the saw blade slot (10) is formed at the upper end of said support frame (10).

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present saw, other and further embodiments of the saw may be devised without departing from the basic scope thereof, and the scope thereof is determined by the claims that follow.

What is claimed is:

1. A saw comprising:
a handle (1);
a locking bolt (2);
a saw blade (3);
a guide block (4); and
a return mechanism (5).

2. The saw of claim 1, wherein the saw blade (3) is installed in a horizontal saw blade hole (7) of the handle (1) through locking bolt (2).

3. The saw of claim 1, wherein the guide block (4) which is parallel to saw blade (3) and can rotate along with the saw blade and move through the handle (1) is installed in a horizontal guide hole (8) on the bottom surface of horizontal saw blade hole (7) in the handle (1).

4. The saw of claim 1 wherein the saw blade (3) passes through a saw blade slot (10) at the upper end of a support frame (9).

5. The saw of claim 4, wherein the support frame (9) that can move along saw blade (3) together with guide block (4) is installed at the end of guide block (4).

6. The saw of claim 1 wherein the return mechanism (5), which is installed inside the upper end of the handle (1) and can drive guide block (4) to move, is connected to a spring clip (15) at the other end of guide block (4).

7. The saw of claim 1 wherein a position limiting device (6) that can stop movement of guide block (4) is installed at the lower end of support frame (9).

8. The saw of claim 1 wherein a hole (16) is formed outside horizontal guide hole (8) at the upper end of handle (1).

9. The saw of claim 1 wherein a horizontal stop piece (11) is installed outside the horizontal guide hole (8).

10. The saw of claim 1, wherein a vertical guide hole (12) and a vertical saw blade hole (13) that are parallel to one another are formed in said handle (1); and wherein a vertical stop piece (14) is installed on one side of vertical guide hole (12) at the lower end of handle (1).

11. The saw of claim 4, wherein the saw blade slot (10) is formed at the upper end of said support frame (10).
